(19) United States
(12) Patent Application Publication
(10) Pub. No.: US 2025/0364844 A1
(43) Pub. Date: Nov. 27, 2025

(54) INDUCTIVE CHARGING DEVICE AND METHOD OF CHARGING AN ELECTRICAL ENERGY STORE

(71) Applicant: Siemens Aktiengesellschaft, München (DE)

(72) Inventors: Young Hun Lee, Baldham (DE); Martin Pavlovsky, München (DE); Alexander Simon, München (DE); Denis Kraus, München (DE); Monika Poebl, München (DE); Michael Finkenzeller, Feldkirchen-Westerham (DE)

(21) Appl. No.: 19/215,642

(22) Filed: May 22, 2025

(30) Foreign Application Priority Data
May 22, 2024 (DE) 10 2024 204 712.0

(51) Int. Cl. H02J 50/70; B60L 53/122; H02J 50/12

(52) U.S. Cl. CPC H02J 50/70; B60L 53/122; H02J 50/12

(57) ABSTRACT

A device inductively charges an electrical energy store, in particular a battery of an electric vehicle. The device has a wallbox circuit having a converter and an output, a ground circuit having an input and a charging coil, and a cable that provides an electrical connection between the output of the wallbox circuit and the input of the ground circuit. A first parallel capacitor is attached to the output of the wallbox circuit and has a first capacitance. A second parallel capacitor is attached to the input of the ground circuit and has a second capacitance. The first capacitance and the second capacitance are selected such that a predetermined resonant frequency of an oscillating circuit having the charging coil and a restriction of an electrical current flowing in the cable are achieved.

### CROSS-REFERENCE TO RELATED APPLICATION

This application claims the priority, under 35 U.S.C. § 119, of German Patent Application DE 10 2024 204 712.0, filed May 22, 2024; the prior application is herewith incorporated by reference in its entirety.

### FIELD AND BACKGROUND OF THE INVENTION

The present invention relates to the field of inductive charging of electrical energy stores, in particular devices for inductively charging an electrical energy store, e.g. a battery of an electric vehicle, to uses of such devices, and to a method.

Known devices for inductively charging batteries, e.g. in electric vehicles, typically consist of two circuits, a wallbox circuit and a ground circuit (ground assembly), which are connected using a cable. This cable must be configured for high current intensities. In addition, EMI filters are needed to limit electromagnetic interference. The required heavy cables and efficient EMI filters are associated with costs and effort.

### SUMMARY OF THE INVENTION

The present invention is based on the object of reducing the currents in the cable between the wallbox circuit and the ground circuit.

A device, its use and a method are described below.

A first aspect of the invention describes a device for inductively charging an electrical energy store, in particular a battery of an electric vehicle. The device has the following: (a) a wallbox circuit having a converter and an output, (b) a ground circuit having an input and a charging coil, (c) a cable that provides an electrical connection between the output of the wallbox circuit and the input of the ground circuit, (d) a first parallel capacitor which is attached to the output of the wallbox circuit and has a first capacitance, and (e) a second parallel capacitor which is attached to the input of the ground circuit and has a second capacitance. The first capacitance and the second capacitance are selected such that a predetermined resonant frequency of an oscillating circuit having the charging coil and a restriction of an electrical current flowing in the cable are achieved.

The device described is based on the finding that, by attaching parallel capacitors to both ends of the cable, i.e. both at the output of the wallbox circuit and at the input of the ground circuit, a considerable reduction in the cable current can be achieved without negatively affecting the charging power. In other words, the same charging power can be achieved with a lower cable current compared to configurations that have no or only a single parallel capacitor (arranged either at the output of the wallbox circuit or at the input of the ground circuit). As a result, the requirements for cables and EMI filters are correspondingly lower, and so the latter can be simpler and more cost-effective.

According to one exemplary embodiment, the first capacitance is equal to the second capacitance.

This exemplary embodiment is particularly easy to implement, since both parallel capacitors have the same capacitance. The latter should only be selected (together with or on the basis of further impedances in the ground circuit) in such a way that the predetermined resonant frequency of the oscillating circuit is set.

According to a further exemplary embodiment, the first capacitance and the second capacitance have a ratio of 1:4 to 4:1, in particular of 1:3 to 3:1.

In other words, the ratio between the first capacitance, hereinafter also called C1, and the second capacitance, hereinafter also called C2, C1/C2 is between 1:4 and 4:1, i.e. ¼≤C1/C2≤4, in particular ⅓≤C1/C2≤3. Carefully determining the capacitances C1 and C2 makes it possible here to minimize (and not just reduce) the cable current.

The sum of the first and second capacitances forms the total parallel capacitance Cp, i.e. Cp=C1+C2, which is relevant to the resonant behavior, and must therefore be determined taking into account the further impedances in the circuits and in the cable. With respect to Cp, the above statements on the ratio between C1 and C2 then result in C1 being between 20% and 80% of Cp, whereas C2 is between 80% and 20% of Cp, in particular C1 being between 25% and 75% of Cp, whereas C2 is between 75% and 25% of Cp.

According to a further exemplary embodiment, the predetermined resonant frequency is contained in the range from 79 kHz to 90 kHz or in the range from 19 kHz to 25 kHz.

The range from 79 kHz to 90 kHz meets the requirements of the standard for inductively charging electric vehicles (SAE J2954 (USA/International) or IEC 61980 (EU)), while the range from 19 kHz to 25 kHz meets the requirements of the standard for inductively charging electric busses (IEC 61980 (EU)).

According to a further exemplary embodiment, the restriction of the electrical current flowing in the cable relates to those current components whose frequency is equal to the predetermined resonant frequency and/or higher than the predetermined resonant frequency.

In other words, current components at the predetermined resonant frequency and/or at higher frequencies, in particular harmonic current components, can be restricted.

A second aspect of the invention describes the use of a device according to the first aspect for charging an electrical energy store, in particular for charging a battery of an electric vehicle.

The use described is essentially based on the same finding as the device described above according to the first aspect, namely that, by attaching parallel capacitors to both ends of the cable, i.e. both at the output of the wallbox circuit and at the input of the ground circuit, a considerable reduction in the cable current can be achieved without negatively affecting the charging power.

A third aspect of the invention describes a method which includes the following: (a) providing a wallbox circuit having a converter and an output, (b) providing a ground circuit having an input and a charging coil, (c) providing a cable that provides an electrical connection between the output of the wallbox circuit and the input of the ground circuit, (d) providing a first parallel capacitor which is attached to the output of the wallbox circuit and has a first capacitance, and (e) providing a second parallel capacitor which is attached to the input of the ground circuit and has a second capacitance. The first capacitance and the second capacitance are selected such that a predetermined resonant frequency of an oscillating circuit having the charging coil and a restriction of an electrical current flowing in the cable are achieved.

The method according to this third aspect is also essentially based on the same idea as the device described above according to the first aspect.

Other features which are considered as characteristic for the invention are set forth in the appended claims.

Although the invention is illustrated and described herein as embodied in an inductive charging device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of an inductive charging device according to the prior art;

FIG. 2 is an illustration of an inductive charging device according to one exemplary embodiment of the present invention;

FIG. 3 is a graph showing the relationship between cable current and frequency for the charging device according to the prior art that is shown in FIG. 1;

FIG. 4 is a graph showing the relationship between a cable current and frequency for the charging device according to the present invention that is shown in FIG. 2; and

FIG. 5 are graphs showing different current profiles in the charging device shown in FIG. 2.

### DETAILED DESCRIPTION OF THE INVENTION

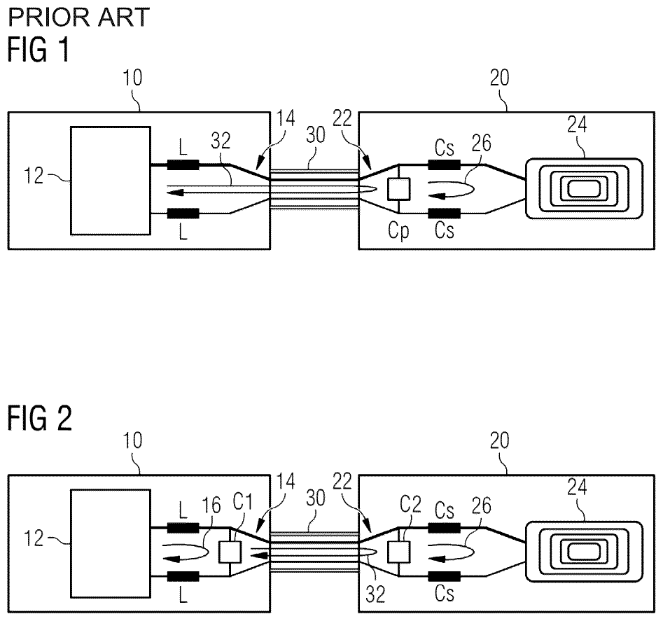

Referring now to the figures of the drawings in detail and first, particularly to FIG. 1 thereof, there is shown an inductive charging device according to the prior art which is configured to inductively charge an electric vehicle via a charging coil installed in the ground, e.g. below a parking space. The charging device has a wallbox circuit 10, a ground circuit 20 and a cable 30. The wallbox circuit has a converter 12, inductances L and an output 14. The ground circuit 20 has an input 22, a parallel capacitor Cp, series capacitors Cs and a charging coil 24. The cable 30 provides an electrical connection between the output 14 of the wallbox circuit 10 and the input 22 of the ground circuit 20. It should be noted that the device has yet further components and features which are not relevant, however, in the present context and are not shown for the sake of simplification.

If an accordingly equipped vehicle, in particular an electric vehicle or a bus, truck or the like, is positioned with a receiver coil above the ground coil 24, the battery of the vehicle can be charged by inductive coupling between the ground coil 24 and the receiver coil. On the one hand, as shown with the arrow 32, a current flows from the wallbox circuit 10 through cable 30, through parallel capacitor Cp and back through cable 30 to the wallbox circuit 10 and, on the other hand, as shown with the arrow 26, a current flows in the oscillating circuit consisting of the parallel capacitor Cp, the two series capacitors Cs and the charging coil 24. As mentioned at the outset, the cable 30 must be configured for the current 32 and equipped with EMI filters.

As explained below, the requirements for cables 30 and EMI filters can be significantly reduced with the aid of the present invention by restricting the current flow in the cable 30.

FIG. 2 shows an inductive charging device according to one exemplary embodiment of the present invention. The charging device according to the invention is very similar to the charging device shown in FIG. 1 and also has a wallbox circuit 10, a ground circuit 20 and a cable 30. The wallbox circuit has a converter 12, inductances L and an output 14. Unlike in the charging device shown in FIG. 1, however, the wallbox circuit 10 additionally has a (first) parallel capacitor C1 attached to the output 14. The ground circuit 20 has an input 22, a (second) parallel capacitor C2, series capacitors Cs and a charging coil 24. The cable 30 provides an electrical connection between the output 14 of the wallbox circuit 10 and the input 22 of the ground circuit 20. It should also be noted here that the device may have yet further components and features which are not relevant, however, in the present context and are not shown for the sake of simplification.

Due to the additional parallel capacitor C1, the current profiles are different than described above in connection with FIG. 1. As indicated with the arrow 16, a current now runs from the converter 12 through the first parallel capacitor C1 and back to the converter 12 during charging. The current through the cable 30, indicated with the arrow 32, is here—due to the current 16—lower than in the prior art device explained above in connection with FIG. 1. The current 26 in the ground circuit 20, indicated with the arrow 26, is almost unchanged. The parallel capacitors should be selected in such a way that C1+C2=Cp. In other words, the device according to the invention differs from the known device shown in FIG. 1 in that the parallel capacitor Cp has been divided into two parallel capacitors: a first parallel capacitor C1 at the output of the wallbox circuit 10 and a second parallel capacitor C2 at the input of the ground circuit 20. Apart from the significantly lower current flow in the cable 30—and the associated advantages—the charging device according to the invention has essentially the same properties as the device from the prior art, in particular with regard to the charging power. The small measure according to the invention of dividing the parallel capacitor Cp into two parallel capacitors C1 and C2 therefore makes it possible to save considerable costs in connection with cable material, shielding and EMI filters and to reduce overall the interference from the device.

There are multiple options for selecting the two parallel capacitors C1 and C2. One simple option is to use two capacitors with an identical capacitance, i.e. C1=C2=Cp/2. In most cases, this option will lead to a significant improvement. However, parallel capacitors with different capacitances can also be used, where a ratio C1/C2 of between 1:4 and 4:1, in particular between 1:3 and 3:1, is advantageous. The total parallel capacitance Cp can also be expressed such that C1 is between 20% and 80% of Cp, whereas C2 is between 80% and 20% of Cp, in particular C1 is between 25% and 75% of Cp, whereas C2 is between 75% and 25% of Cp. These possible variations can in particular influence which spectral components of the current in the cable 30 are particularly restricted. In some cases, the current component at the resonant frequency is a particular problem, and, in other cases, in particular one or more harmonic current components, i.e. current components whose frequency is higher than the resonant frequency, must be restricted.

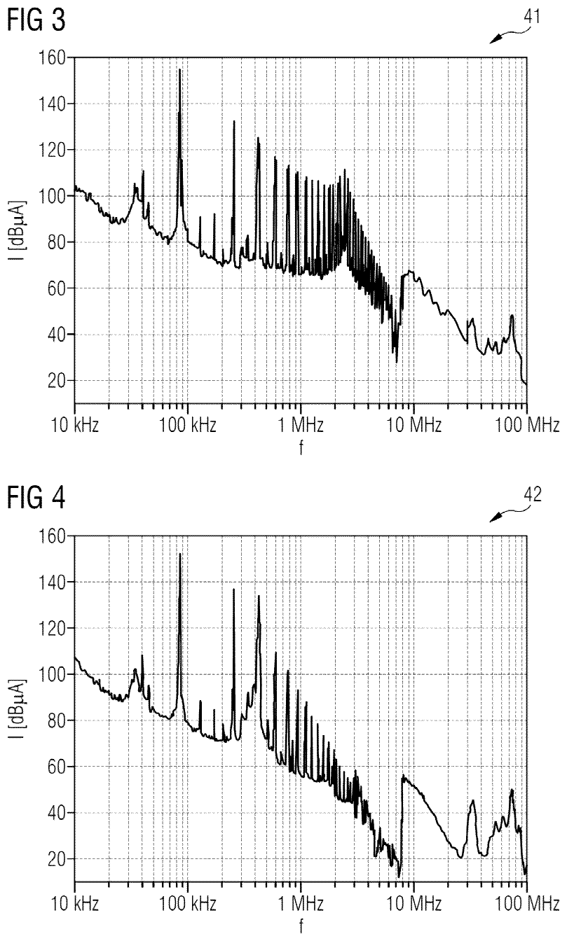

FIG. 3 shows a representation 41 of the relationship between cable current I (dBμA) and frequency f (Hz) for the charging device according to the prior art that is shown in FIG. 1. The predetermined resonant frequency is 85 kHz in the example shown and thus corresponds to the standard for charging electric vehicles. The highest value of the current intensity, I≈155 dBμA, is therefore also found at this frequency. For frequencies between 85 kHz and approximately 3 MHz, a number of harmonics are recognizable, with the current intensity exceeding 100 dBμA. For frequencies above 3 MHz, the current intensity drops significantly.

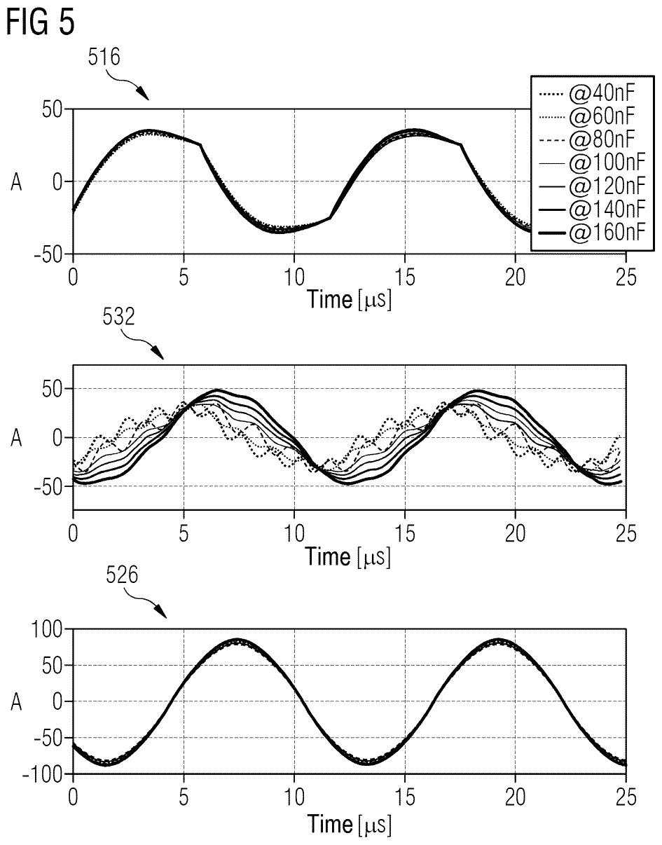

FIG. 4 shows a representation 42 of the relationship between cable current I (dBμA) and frequency f (Hz) for the charging device according to the present invention that is shown in FIG. 2. In the example shown, the ratio between the capacitances C1/C2 is 1:2. Here, too, the predetermined resonant frequency is equal to 85 kHz, but the current intensity here is slightly lower in comparison with the representation 41, 1≈150 dBμA. A significant reduction in the harmonics is also evident, in particular for frequencies above 1 MHz, where the current intensity is approximately 20 dBμA lower. Thus, the EMI filters can be designed to be accordingly lower and the cable 30 can be graded to these lower currents.

FIG. 5 shows different current profiles in the charging device according to the invention, shown in FIG. 2, for different ratios between the capacitances of the parallel capacitors C1 and C2. More specifically, the upper graph 516 in FIG. 5 shows the temporal profile of the converter current 16 (cf. FIG. 2) for C1=40 nF, C1=60 nF, C1=80 nF, C1=100 nF, C1=120 nF, C1=140 nF and C1=160 nF, where the total parallel capacitance Cp is always the same: Cp=C1+C2=270 nF. It should be noted that the capacitances mentioned here should be understood only as examples and that many other values are possible. The middle graph 532 shows the respective corresponding temporal profile of the cable current 32 (cf. FIG. 2). Here it can be seen that, for the three smallest values of C1, i.e. C1=40 nF, C1=60 nF and C1=80 nF, significantly stronger overshoots occur than for the other cases. Thus, for C1>80 nF, less high-frequency interference will occur due to the cable current. On the other hand, the attenuation of the cable current becomes lower for higher values of C1. The lower graph 526 shows the respective corresponding temporal profile of the coil current 26 (cf. FIG. 2). Variations are hardly recognizable here, i.e. the ratio C1/C2 does not play a significant role for the coil current.

It should be noted that the term “having” does not exclude other elements or steps and that the use of the article “a/an” does not exclude a multiplicity. Elements that are described in connection with various embodiments can also be combined. It should also be noted that reference signs in the claims should not be interpreted as limiting the scope of the claims.

The following is a summary list of reference numerals and the corresponding structure used in the above description of the invention:
10 Wallbox circuit
12 Converter
14 Output
16 Arrow
20 Ground circuit
22 Input
24 Charging coil
26 Arrow
30 Cable
32 Arrow
41 Representation
42 Representation
Cp Parallel capacitor
Cs Series capacitor
C1 Parallel capacitor
C2 Parallel capacitor
F Frequency
I Current intensity
L Inductance

1. A device for inductively charging an electrical energy store, the device comprising:
a wallbox circuit having a converter and an output;
a ground circuit having an input and a charging coil;
a cable providing an electrical connection between said output of said wallbox circuit and said input of said ground circuit;
a first parallel capacitor attached to said output of said wallbox circuit and having a first capacitance; and
a second parallel capacitor attached to said input of said ground circuit and having a second capacitance, the first capacitance and the second capacitance being selected such that a predetermined resonant frequency of an oscillating circuit having said charging coil and a restriction of an electrical current flowing in said cable are achieved.

2. The device according to claim 1, wherein the first capacitance is equal to the second capacitance.

3. The device according to claim 1, wherein the first capacitance and the second capacitance have a ratio of 1:4 to 4:1.

4. The device according to claim 1, wherein the predetermined resonant frequency is contained in a range from 79 kHz to 90 kHz.

5. The device according to claim 1, wherein the restriction of the electrical current flowing in said cable relates to current components whose frequency is equal to the predetermined resonant frequency and/or higher than the predetermined resonant frequency.

6. The device according to claim 1, wherein the first capacitance and the second capacitance have a ratio of 1:3 to 3:1.

7. The device according to claim 1, wherein the predetermined resonant frequency is contained in a range from 19 kHz to 25 kHz.

8. The device according to claim 1, wherein the device is configured for inductively charging a battery of an electric vehicle.

9. A method for charging an electrical energy store, which comprises the steps of:
providing the device according to claim 1; and
charging the electrical energy store using the device.

10. The method according to claim 9, wherein the electrical energy store is a battery of an electric vehicle.

11. A method, which comprises the step of:
providing a wallbox circuit having a converter and an output;
providing a ground circuit having an input and a charging coil;
providing a cable providing an electrical connection between the output of the wallbox circuit and the input of the ground circuit;
providing a first parallel capacitor attached to the output of the wallbox circuit and having a first capacitance; and
providing a second parallel capacitor attached to the input of the ground circuit and having a second capacitance, wherein the first capacitance and the second capacitance are selected such that a predetermined resonant frequency of an oscillating circuit having the charging coil and a restriction of an electrical current flowing in the cable are achieved.
